(19) United States
(12) Patent Application Publication
(10) Pub. No.: US 2024/0278166 A1
(43) Pub. Date: Aug. 22, 2024

(54) CARBON BYPRODUCT REMOVAL MODULE, CARBON BYPRODUCT REMOVAL SYSTEM, AND OPERATING METHOD THEREOF

(71) Applicant: SAMSUNG ELECTRONICS CO., LTD., SUWON-SI (KR)

(72) Inventors: Song Yi BAEK, Suwon-si (KR); Jae Hyun KIM, Suwon-si (KR); Hwan Soo HEO, Suwon-si (KR); Dae Wee KONG, Suwon-si (KR); Sang Ho ROH, Suwon-si (KR)

(21) Appl. No.: 18/434,923

(22) Filed: Feb. 7, 2024

(30) Foreign Application Priority Data
Feb. 17, 2023 (KR) 10-2023-0021676
May 2, 2023 (KR) 10-2023-0057096

(51) Int. Cl. B01D 53/00; B01D 53/34; B01D 53/46; B01D 53/76

(52) U.S. Cl. CPC B01D 53/007; B01D 53/346; B01D 53/46; B01D 53/76; B01D 2251/102; B01D 2258/0216; B01D 2259/10; B01D 2259/804

(57) ABSTRACT

A carbon byproduct removal module includes: a vaporizer configured to produce vapor including oxygen atoms; a carrier gas supplier connected to the vaporizer and configured to supply carrier gas to the vaporizer, wherein the carrier gas carries the vapor to a UV-ray irradiator; and the UV-ray irradiator configured to emit ultraviolet rays to the vapor, wherein a first end of the UV-ray irradiator is connected to a first end of the vaporizer, wherein a second end of the UV-ray irradiator is attached to an exhaust module connected to a chamber in which a semiconductor manufacturing process is performed.

### CROSS-REFERENCE TO RELATED APPLICATION

This application claims priority under 35 USC § 119 to Korean Patent Application No. 10-2023-0021676 filed on Feb. 17, 2023 and No. 10-2023-0057096 filed on May 2, 2023 in the Korean Intellectual Property Office, the disclosures of which are incorporated by reference herein in their entireties.

### TECHNICAL FIELD

The present inventive concept relates to a carbon byproduct removal module, a carbon byproduct removal system, and a method of operating the same.

### DISCUSSION OF THE RELATED ART

Generally, a semiconductor manufacturing process for manufacturing a semiconductor device, including an etching process and a deposition process may use various chemicals. Thus, various contaminants may be produced during the semiconductor manufacturing process. Since these contaminants may be deposited on a surface of a wafer such that impurities may invade a thin film, the wafer may be damaged. Thus, the contaminants should be properly discharged out of the chamber.

An inside of a chamber should be kept in a vacuum state while the semiconductor manufacturing process is being performed. To this end, a pump may be connected to the chamber. The pump may control a pressure inside the chamber or discharge the contaminants inside the chamber. When the contaminants accumulate in a discharge device for the chamber, such as the pump, the discharge device might not operate normally, and thus, the wafer in the chamber may be damaged. To prevent damage being done to the wafer and to properly discharge the contaminants that are inside the chamber, research on a scheme to efficiently remove the contaminants adsorbed to the discharge device is in progress.

### SUMMARY

According to an embodiment of the present inventive concept, a carbon byproduct removal module includes: a vaporizer configured to produce vapor including oxygen atoms; a carrier gas supplier connected to the vaporizer and configured to supply carrier gas to the vaporizer, wherein the carrier gas carries the vapor to a UV-ray irradiator; and the UV-ray irradiator configured to emit ultraviolet rays to the vapor, wherein a first end of the UV-ray irradiator is connected to a first end of the vaporizer, wherein a second end of the UV-ray irradiator is attached to an exhaust module connected to a chamber in which a semiconductor manufacturing process is performed.

According to an embodiment of the present inventive concept, a carbon byproduct removal system includes: a chamber in which a semiconductor manufacturing process is performed; an exhaust module connected to the chamber; and a carbon byproduct removal module attached to the exhaust module and configured to remove a carbon byproduct that is inside the exhaust module, wherein the exhaust module includes: a vacuum pump connected to the chamber and configured to maintain an inside of the chamber in a vacuum state or to discharge the byproduct produced in the chamber while the semiconductor manufacturing process is in progress; a foreline connected to and disposed between the chamber and the vacuum pump; a scrubber connected to the vacuum pump and configured to remove the byproduct that is produced in the chamber; and a P-S line connected to and disposed between the vacuum pump and the scrubber, wherein the carbon byproduct removal module includes: a vaporizer configured to produce vapor including oxygen; a carrier gas supplier configured to supply carrier gas to the vaporizer, wherein the carrier gas carries the vapor to a UV-ray irradiator; and the UV-ray irradiator configured to emit ultraviolet rays to the vapor.

According to an embodiment of the present inventive concept, a method for removing a carbon byproduct includes: providing a chamber in which a semiconductor manufacturing process is performed; providing an exhaust module configured to exhaust an inside of the chamber; providing a carbon byproduct removal module configured to remove the carbon byproduct inside the exhaust module; and attaching the carbon byproduct removal module to the exhaust module to remove the carbon byproduct that is inside the exhaust module, wherein removing the carbon byproduct that is inside the exhaust module by using the carbon byproduct removal module includes: producing, by a vaporizer, vapor including oxygen atoms; supplying, by a carrier gas supplier, carrier gas to the vaporizer such that the carrier gas carries the vapor from the vaporizer to a UV-ray irradiator; emitting, by the UV-ray irradiator, ultraviolet rays to the vapor to produce first oxygen radicals; and bringing the first oxygen radicals into contact with the carbon byproduct inside the exhaust module to remove the carbon byproduct.

### BRIEF DESCRIPTION OF DRAWINGS

The above and features of the present inventive concept will become more apparent by describing in detail some example embodiments thereof with reference to the attached drawings, in which:

FIG. 1 is a diagram illustrating a carbon byproduct removal module according to some embodiments of the present inventive concept.

FIGS. 2, 3, 4 and 5 are diagrams illustrating a carbon byproduct removal system according to some embodiments of the present inventive concept.

FIG. 6 is a diagram illustrating a carbon byproduct removal system according to some embodiments of the present inventive concept.

FIG. 7 is a diagram illustrating a carbon byproduct removal system according to some embodiments of the present inventive concept.

FIG. 8 is a diagram illustrating a carbon byproduct removal system according to some embodiments of the present inventive concept.

FIG. 9 is a diagram illustrating a carbon byproduct removal system according to some embodiments of the present inventive concept.

FIG. 10 is a diagram illustrating a carbon byproduct removal system according to some embodiments of the present inventive concept.

FIG. 11 is a flowchart illustrating a carbon byproduct removal method according to some embodiments of the present inventive concept.

FIGS. 12, 13, 14 and 15 are diagrams of intermediate steps illustrating the carbon byproduct removal method according to some embodiments of the present inventive concept.

FIG. 16 and FIG. 17 are diagrams illustrating a carbon byproduct removal effect according to some embodiments of the present inventive concept.

### DETAILED DESCRIPTIONS OF THE EMBODIMENTS

For simplicity and clarity of illustration, elements in the drawings are not necessarily drawn to scale. The same reference numbers in different drawings and the specification represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present inventive concept may be practiced without these specific details. Examples of various embodiments are illustrated and described further below. It will be understood that the description herein is not intended to limit the claims to the specific embodiments described. On the contrary, it is intended to cover alternatives, modifications, and equivalents as may be included in the idea and scope of the present disclosure as defined by the appended claims.

A shape, a size, a ratio, an angle, a number, etc. disclosed in the drawings for illustrating embodiments of the present inventive concept are illustrative, and the present inventive concept is not limited thereto. The same reference numerals refer to the same elements herein.

The terminology used herein is for the purpose of describing particular embodiments only and is not intended to limit the present inventive concept. As used herein, the singular forms “a” and “an” are intended to include the plural forms as well, unless the context clearly indicates otherwise. As used herein, the term “and/or” includes any and all combinations of one or more of the associated listed items. When referring to “C to D”, this means C inclusive to D inclusive unless otherwise specified.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described under could be termed a second element, component, region, layer or section, without departing from the spirit, idea, and scope of the present inventive concept.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between the first and second elements or layers. It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may be present.

Further, as used herein, when a layer, film, region, plate, or the like may be disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like may be disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

In one example, when a certain embodiment may be implemented differently, a function or operation specified in a specific block may occur in a sequence different from that specified in a flowchart. For example, two consecutive blocks may actually be executed at the same time. Depending on a related function or operation, the blocks may be executed in a reverse sequence.

In descriptions of temporal relationships, for example, temporal relationships between two events being described by temporal terms such as “after”, “subsequent to”, “before”, etc., another event may occur between the two events unless “directly after”, “directly subsequent” or “directly before” is indicated.

The features of the various embodiments of the present inventive concept may be partially or entirely combined with each other, and may be technically associated with each other or operate with each other. The embodiments may be implemented independently of each other and may be implemented together in an association relationship.

Spatially relative terms, such as “beneath,” “below,” “lower,” “under,” “above,” “upper,” and the like, may be used herein for ease of explanation to describe one element or feature's relationship to another element or feature as illustrated in the figures. It will be understood that the spatially relative terms are intended to encompass different orientations of the device in use or in operation, in addition to the orientation depicted in the figures. For example, when the device in the drawings may be turned over, elements described as “below” or “beneath” or “under” other elements or features would then be oriented “above” the other elements or features. Thus, the example terms “below” and “under” may encompass both an orientation of above and below. The device may be otherwise oriented, for example, rotated 90 degrees or at other orientations, and the spatially relative descriptors used herein may be interpreted accordingly.

Hereinafter, a carbon byproduct removal module, a carbon byproduct removal system, and a carbon byproduct removal method according to some embodiments of the present inventive concept will be described with reference to the accompanying drawings.

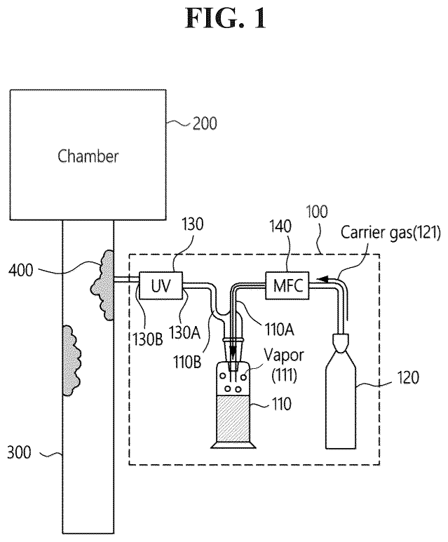

FIG. 1 is a diagram illustrating a carbon byproduct removal module according to some embodiments of the present inventive concept.

Referring to FIG. 1, a carbon byproduct removal module 100 according to some embodiments of the present inventive concept may be attached to an exhaust module 300 of a chamber 200. Inside the chamber 200, a process of manufacturing a semiconductor device using a material including carbon (C) may be performed. For example, inside the chamber 200, a chemical vapor deposition (CVD) process for depositing a thin film on a surface of a wafer using reaction gas such as methane (CH₄), propene (C₃H₆), and benzene (C₆H₆) may be performed. However, the present inventive concept is not limited thereto. While the process of manufacturing the semiconductor device using a material including carbon is being performed inside the chamber 200, a carbon byproduct may be produced as a result of a reaction inside the chamber 200. The carbon byproduct inside the chamber 200 may be deposited on the surface of the wafer and make the thin film impure and a surface thereof rough. Thus, it is desirable for the carbon byproduct to be discharged out of the chamber 200. Accordingly, the exhaust module 300 is provided in the chamber 200 to discharge the carbon byproduct produced as a result of the reaction in the inside of the chamber 200 out of the chamber 200.

In one example, while the carbon byproduct inside the chamber 200 is discharged to the outside through the exhaust module 300, a carbon byproduct 400 might not be discharged out of the exhaust module 300 but may accumulate inside the exhaust module 300. Thus, the carbon byproduct removal module 100 is attached to a point of an inner area of the exhaust module 300 where the carbon byproduct 400 is adsorbed to remove the carbon byproduct 400. The carbon byproduct removal module 100 may include a vaporizer 110, a carrier gas supplier 120, and an UV-ray irradiator (e.g., a UV lamp or a UV activator) 130.

The vaporizer 110 may produce a vapor including oxygen atom (O). The vaporizer 110 may apply ultrasonic vibration to a material in a liquid state inside the vaporizer to produce vapor in a mist state. In this regard, a scheme in which the vaporizer 110 produces the vapor is not limited thereto. The material in a liquid state from which the vaporizer 110 produces the vapor including the oxygen atoms may be, for example, hydrogen peroxide (H₂O₂). In some embodiments of the present inventive concept, ultrasonic waves may be generated and applied to a bottom of the vaporizer 110 including the liquid hydrogen peroxide (H₂O₂) such that ultrasonic vibration may be applied to the liquid hydrogen peroxide (H₂O₂) to produce the vapor containing the oxygen atoms. However, an embodiment of the present inventive concept is not limited thereto, and the vapor containing the oxygen atoms may be produced using another material used to produce the vapor containing the oxygen atoms. Furthermore, according to an embodiment of the present inventive concept, a gaseous material other than a liquid material, for example, gaseous hydrogen peroxide (H₂O₂) used to produce oxygen radicals may be supplied to the inside of the vaporizer 110.

The carrier gas supplier 120 may supply carrier gas used to move the vapor produced by the vaporizer 110 to the UV-ray irradiator 130 to the vaporizer 110. For example, the carrier gas may be an inert gas such as argon (Ar) or nitrogen (N₂), CDA (Clean Dry Air), or a gas including oxygen atoms such as oxygen (O₂) or the like. The carrier gas may be composed of a single gas including the inert gas or the gas including the oxygen atoms, or a combination of the inert gas and the gas including the oxygen atom. One end 110A of the vaporizer 110 may be connected to the carrier gas supplier 120 so that the carrier gas may be supplied from the carrier gas supplier 120 to the vaporizer 110. The carrier gas supplied to the vaporizer 110 together with the vapor including the oxygen atoms produced by the vaporizer 110 may flow toward the UV-ray irradiator 130.

In some embodiments of the present inventive concept, a mass flow controller (MFC) 140 may be connected to and disposed between the carrier gas supplier 120 and the one end 110A of the vaporizer 110. The mass flow controller 140 may measure an amount of the carrier gas flowing from the carrier gas supplier 120 to one end 110A of the vaporizer 110 using an internal sensor, and may compare the measured amount of the carrier gas with a preset amount of the carrier gas. In addition, the mass flow controller 140 may control a flow rate of the carrier gas using an internal valve so that the measured amount of the carrier gas is equal to the preset amount of the carrier gas. Accordingly, the mass flow controller 140 may adjust the amount of the carrier gas 121 supplied to the vaporizer 110 to be sufficient such that the vapor 111 produced in the vaporizer 110 may reach the UV-ray irradiator 130.

One end 130A of the UV-ray irradiator 130 may be connected to the other end 110B of the vaporizer 110, and thus, the UV-ray irradiator 130 may receive the vapor 111 including the oxygen atoms and the carrier gas 121 from the vaporizer 110. The UV-ray irradiator 130 may be embodied as, for example, an ultraviolet lamp that emits light including ultraviolet rays. The UV-ray irradiator 130 may emit light including ultraviolet light to the vapor 111 including the oxygen atoms and the carrier gas 121. The vapor 111 including the oxygen atoms may receive energy from the ultraviolet rays emitted from the UV-ray irradiator 130 and may be converted to highly reactive oxygen radicals. The highly reactive oxygen radicals may move into the exhaust module 300 of the chamber 200 connected to the other end 130B of the UV-ray irradiator 130 and may react with the carbon byproduct 400 adsorbed on an inner surface of the exhaust module 300.

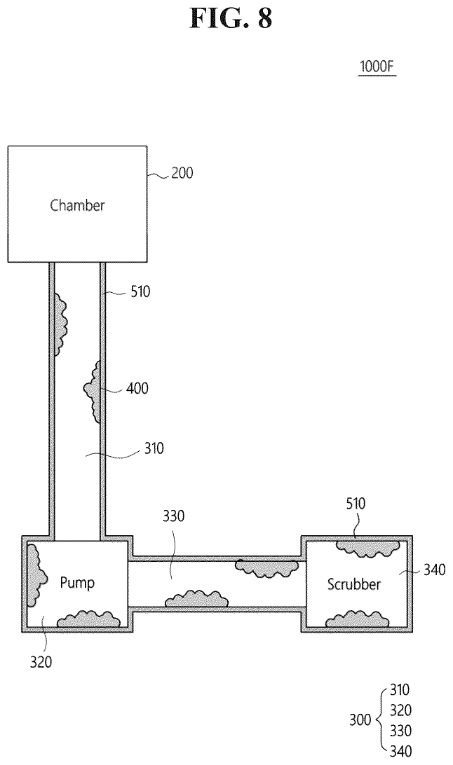

The oxygen radicals may react with the carbon byproduct 400 inside the exhaust module 300 to decompose the carbon byproduct 400. In addition, the oxygen radical may react with the carbon byproduct 400 inside the exhaust module 300 to bring the carbon byproduct 400 into a state in which the carbon byproduct is easily removable. For example, the oxygen radicals may convert the carbon byproduct 400 into a material that may be vaporized at low temperatures. Accordingly, when heat at a temperature equal to or higher than a boiling point of the carbon byproduct 400 is applied to the exhaust module 300 to vaporize or sublimate the carbon byproduct 400 to remove the carbon byproduct from the exhaust module 300, the carbon byproduct 400 may be removed at a lower temperature than a temperature used in a conventional manner. The process of removing the carbon byproduct 400 by applying the heat to the exhaust module 300 will be described later with reference to FIG. 8 to FIG. 10.

In general, the carbon byproduct 400 adsorbed on the inner surface of the exhaust module 300 as a result of the semiconductor manufacturing process may be a high-viscosity polymer material. In this regard, when an internal temperature of the exhaust module 300 is lower than the boiling point of the carbon byproduct 400, the carbon byproduct 400 may be adsorbed on the inner surface of the exhaust module 300. In some embodiments of the present inventive concept, the carbon byproduct removal module 100 may be attached to the exhaust module 300 of the chamber 200 to allow the carbon byproduct 400 adsorbed on the inner surface of the exhaust module 300 to react with the oxygen radicals, such that the carbon byproduct 400 may be efficiently removed.

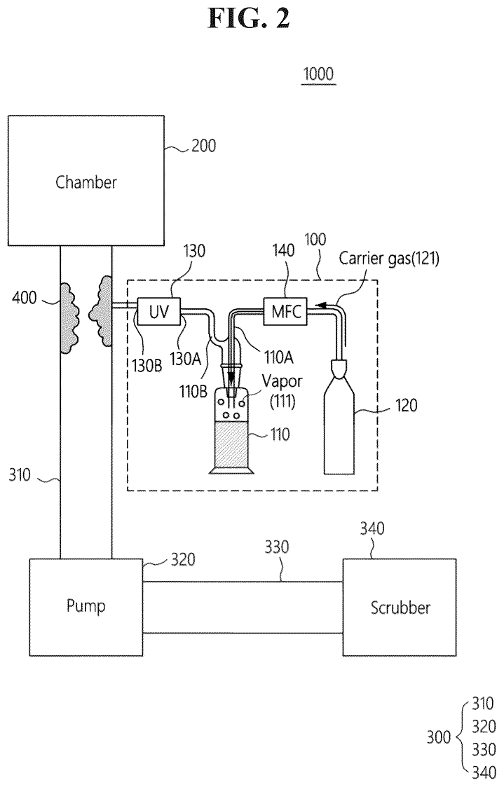

FIG. 2 to FIG. 5 are diagrams illustrating a carbon byproduct removal system according to some embodiments of the present inventive concept. Hereinafter, those duplicate with the descriptions of the previous embodiment may be omitted or briefly discussed, and following description will focus on the differences.

First, referring to FIG. 2, a carbon byproduct removal system 1000 may include the chamber 200, the exhaust module 300, and the carbon byproduct removal module 100. The exhaust module 300 may include a vacuum pump 320, a foreline, 310, a scrubber 340, and a P-S line 330.

The vacuum pump 320 may be configured to maintain a vacuum inside the chamber 200 or discharge the byproducts produced inside the chamber 200 while the semiconductor manufacturing process is in progress inside the chamber 200. For example, the vacuum pump 320 may be a dry pump, and may be implemented to have a roots rotor, a screw rotor, or a combination of the roots rotor and the screw rotor. The roots rotor may be connected to the chamber 200 to suck and compress the byproduct produced in the chamber 200. Furthermore, the screw rotor may discharge gases and byproducts sucked by the roots rotor out of the chamber 200.

The vacuum pump 320 may be connected to the chamber 200 via the foreline 310. The foreline 310 may be connected to the vacuum pump 320 to discharge gas pumped to vacuum the inside of the chamber 200 and the byproducts. An inside of the foreline 310 may be maintained at a pressure of about 1 Torr to prevent the byproduct from flowing back into the chamber 200. Since the foreline 310 serves as a passage through which the byproduct inside the chamber 200 is discharged out of the chamber 200, the carbon byproduct 400 may be adsorbed on an inner surface of the foreline 310. Therefore, the carbon byproduct removal module 100 may be attached to a point of the inner surface of the foreline 310, to which the carbon byproduct 400, is adsorbed to remove the carbon byproduct 400 or convert the carbon byproduct 400 into a state in which the carbon byproduct 400 is easily removed.

The scrubber 340 may be connected to the vacuum pump 320 and may remove the byproduct produced in the chamber 200. For example, the scrubber 340 may be embodied as a burn-wet scrubber, which burns discharged gas and then sprays a cleaning solution to the burnt discharged gas to remove the byproducts therefrom. However, a scheme in which the scrubber 340 removes the byproduct is not limited thereto. The scrubber 340 may remove the byproduct inside the chamber 200 by using plasma or in an adsorption manner, or using catalyst. The P-S line 330 may be an exhaust line connecting the vacuum pump 320 and the scrubber 340 to each other. An inside of the P-S line 330 may be maintained at a pressure of about 760 Torr.

In this way, the carbon byproduct produced during the semiconductor manufacturing process may be absorbed not only on the inner surface of the chamber 200 but also on the inner surface of each of all components of the exhaust module 300. When a state, in which the carbon byproduct 400 adheres to any component of the exhaust module 300, lasts, the performance of the exhaust module 300 may deteriorate or, the operation of the exhaust module 300 may stop. To prevent this situation, it is desirable to periodically check a state of the inside of the exhaust module 300 and prevent the carbon byproduct 400 from accumulating on the inner surface of the exhaust module 300 by an amount larger than or equal to a predefined amount. In some embodiments of the present inventive concept, a check period of the exhaust module 300 may be increased by attaching the carbon byproduct removal module 100 to the exhaust module 300 to remove the carbon byproduct 400 or convert the carbon byproduct 400 into a state in which the carbon byproduct 400 is easily removed.

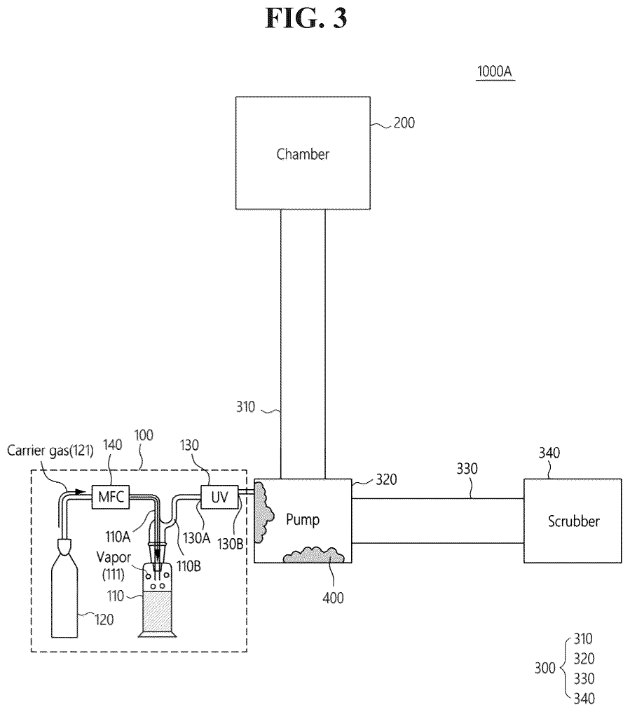

FIG. 2 shows an example where the carbon byproduct removal module 100 is attached to the foreline 310 among the components of the exhaust module 300. An embodiment is not limited thereto. For example, the carbon byproduct removal module 100 may be attached to any of other components of the exhaust module 300. For example, referring to FIG. 3, in a carbon byproduct removal system 1000A, the carbon byproduct removal module 100 may be attached to the vacuum pump 320 to remove the carbon byproduct 400 that is adsorbed on an inner surface of the vacuum pump 320 or convert the carbon byproduct 400 in a state in which the carbon byproduct 400 is vaporized at low temperature. When the carbon byproduct 400 is stuck in the roots rotor and/or screw rotor installed inside the vacuum pump 320, or is fixedly stuck in a gap between the roots rotor and/or screw rotor and an inner wall of the vacuum pump 320, damage may occur to the rotor, and thus the performance of the vacuum pump 320 may deteriorate. Accordingly, the carbon byproduct 400 may be appropriately removed by attaching the carbon byproduct removal module 100 to a point of the inner surface of the vacuum pump 320 onto which the carbon byproduct 400 is adsorbed.

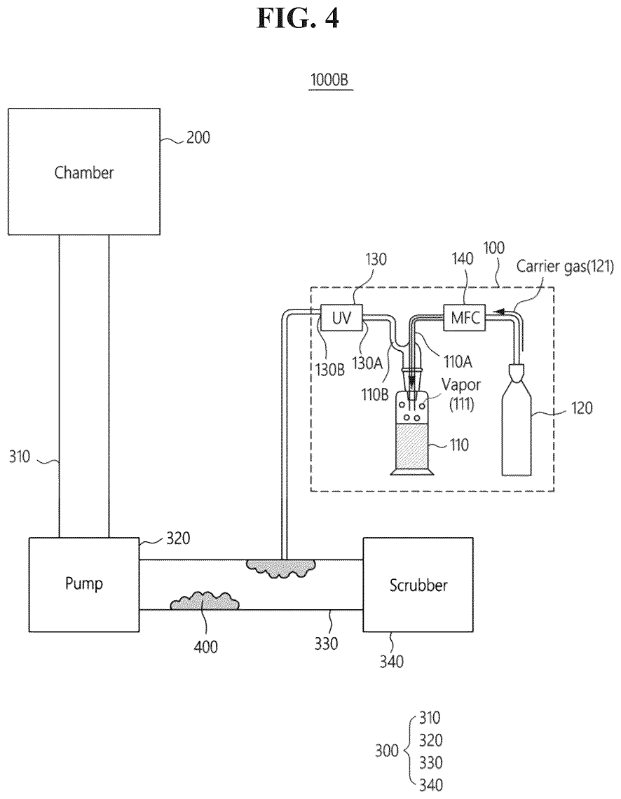

Next, referring to FIG. 4, in a carbon byproduct removal system 1000B, the carbon byproduct removal module 100 may be attached to a point of an inner surface of the P-S line 330, onto which the carbon byproduct 400 is adsorbed, and the carbon byproduct removal module 100 may move the carbon byproduct 400 from the vacuum pump 320 to the scrubber 340 in which the carbon byproduct 400 may be efficiently removed.

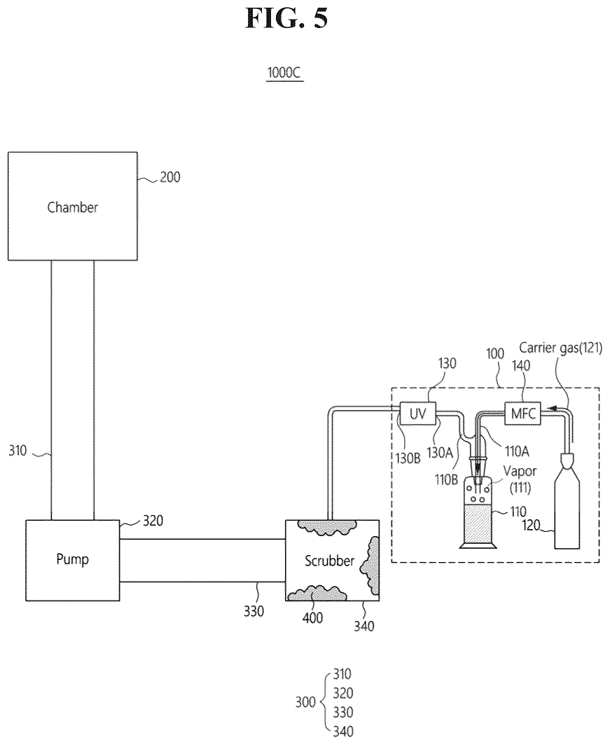

Furthermore, referring to FIG. 5, in a carbon byproduct removal system 1000C, the carbon byproduct removal module 100 may be attached to a point of an inner surface of the scrubber 340 onto which the carbon byproduct 400 is adsorbed, so that the scrubber 340 removes the carbon byproduct 400 more efficiently.

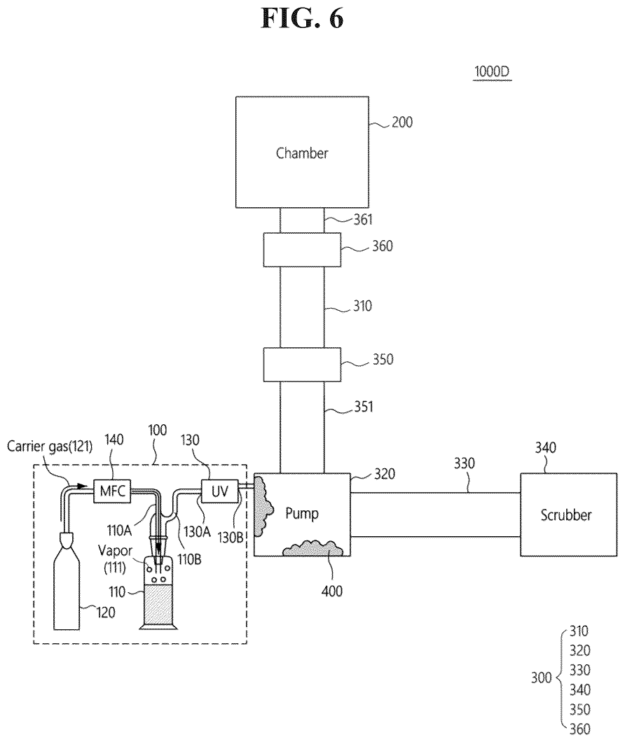

FIG. 6 is a diagram illustrating a carbon byproduct removal system according to some embodiments of the present inventive concept. In the following description, descriptions duplicate with those of the previous embodiments may be omitted or briefly discussed, and following descriptions focus on differences.

Referring to FIG. 6, a carbon byproduct removal system 1000D may further include an AGV (Auto Gate Shutoff Valve) 350 connected to and disposed between the chamber 200 and the vacuum pump 320. The AGV 350 may be configured to prevent contamination of the wafer inside the chamber 200 in an event when an operation of the vacuum pump 320 is stopped due to an external defect or an internal defect of the vacuum pump 320. For example, when the operation of the vacuum pump 320 is stopped because the carbon byproduct 400 is stuck in the screw rotor of the vacuum pump 320, the byproduct may flow back into the chamber 200, and thus, the wafer may be contaminated by the byproduct. In this regard, the AGV 350 may receive a signal indicating the stop of the operation of the vacuum pump 320 from an external controller, and may block a first exhaust line 351 between the AGV 350 and the vacuum pump 320. In addition, the AGV 350 may block the foreline 310 between the AGV 350 and the chamber 200. Thus, the backflow of the byproduct into the chamber 200 may be prevented.

Furthermore, the carbon byproduct removal system 1000D may further include a throttle valve 360 connected to and disposed between the chamber 200 and the foreline 310. The throttle valve 360 opens and closes a pipeline to control an amount of gaseous material flowing into the chamber 200 through a second exhaust line 361 and an amount of gaseous material discharged out of the chamber 200 through the second exhaust line 361, thereby controlling an exhaust pressure inside the chamber 200.

FIG. 6 shows an example where the carbon byproduct removal module 100 is attached to the vacuum pump 320. However, an embodiment is not limited thereto. For example, the carbon byproduct removal module 100 may be attached to any point of an inner surface of each of all of components of the exhaust module 300 onto which the carbon byproduct 400 is adsorbed to remove the carbon byproduct 400 or convert the carbon byproduct 400 into a state in which the carbon byproduct 400 is easily removed. For example, the carbon byproduct removal module 100 may be attached to the AGV 360 or the throttle valve 360 of the exhaust module 300. Accordingly, the carbon byproduct removal module 100 may prevent the damage to the wafer that is inside the chamber 200 or may prevent the carbon byproduct 400 from being adsorbed to the AGV 360 and/or the throttle valve 360 that control the exhaust pressure inside the chamber 200 to suppress defects in the semiconductor manufacturing process inside the chamber 200.

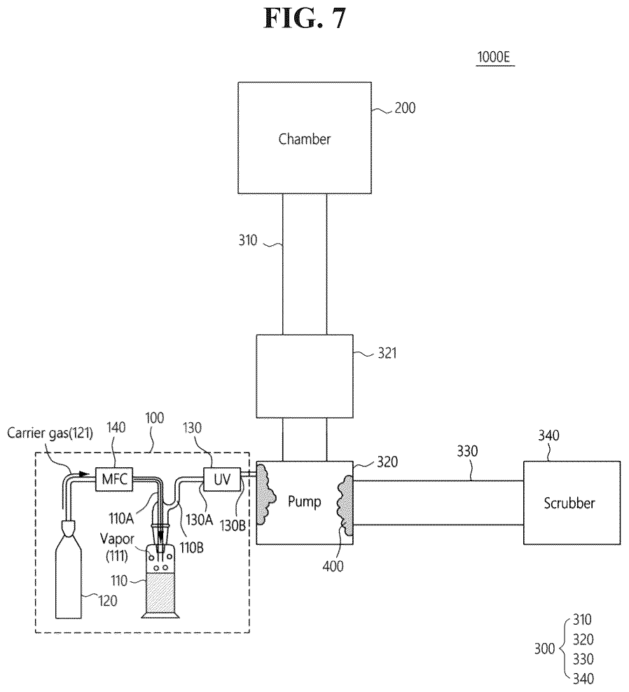

FIG. 7 is a diagram illustrating a carbon byproduct removal system according to some embodiments of the present inventive concept.

Referring to FIG. 7, a carbon byproduct removal system 1000E may further include a booster pump 321 connected to and disposed between the foreline 310 and the vacuum pump 320. The booster pump 321 may be configured to increase an exhaust ability. For example, the booster pump 321 is provided together with the vacuum pump 320 in a form of the dry pump to achieve a higher pump speed and a lower vacuum level than those achieved when the vacuum pump 320 is used alone.

FIG. 8 is a diagram illustrating a carbon byproduct removal system according to some embodiments of the present inventive concept.

Referring to FIG. 8, a carbon byproduct removal system 1000F may include a heat jacket 510 covering an outer surface of the exhaust module 300 that is connected to the chamber 200. For example, the heat jacket 510 may be configured to cover an entirety of the outer surface of the exhaust module 300. For example, the heat jacket 510 may be made of a thermal insulating material integrally covering outer surfaces of the foreline 310, the vacuum pump 320, the P-S line 330, and the scrubber 340. In addition, in an embodiment of the present inventive concept, the heat jacket 510 may be configured to cover only an outer surface of each of at least one of the components of the exhaust module 300. For example, when it is necessary to remove only the carbon byproduct adsorbed on the inner surface of the scrubber 340, at least the outer surface of the scrubber 340 of the exhaust module 300 may be covered with the heat jacket 510. Hereinafter, an example in which the heat jacket 510 covers the outer surface of the exhaust module 300 will be described.

The heat jacket 510 applies heat to the exhaust module 300 and prevents heat from being discharged therefrom, thereby maintaining the inside of the exhaust module 300 at a substantially constant temperature. According to some embodiments of the present inventive concept, the heat jacket 510 may maintain the inside of the exhaust module 300 at about 120°° C. to about 250° C. Accordingly, the heat jacket 510 may heat the carbon byproduct 400 adsorbed on the inner surface of each of the foreline 310, the vacuum pump 320, the P-S line 330, and the scrubber 340 of the exhaust module 300, such that the reaction byproduct discharged from the chamber 200 is prevented from being fixed to the exhaust module 300. For example, the carbon byproduct 400 adsorbed on the inner surface of the exhaust module 300 may be in a high-viscosity liquid state. Thus, the heat jacket 510 may apply the heat of the temperature above the boiling point to the carbon byproduct 400, such that the carbon byproduct 400 may be brought into a gaseous state, or may be solidified, and then, be removed from the exhaust module 300.

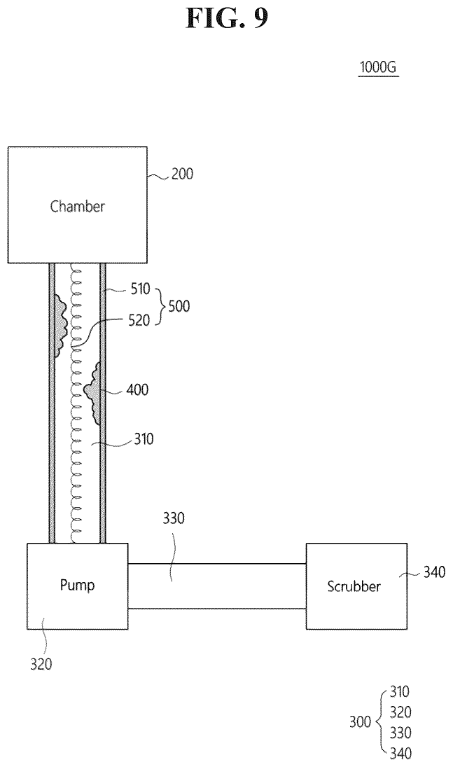

FIG. 9 is a diagram illustrating a carbon byproduct removal system according to some embodiments of the present inventive concept.

Referring to FIG. 9, a carbon byproduct removal system 1000G may include a heating module 500 provided on at least a portion of the exhaust module 300. The heating module 500 may include the heat jacket 510 covering the outer surface of the exhaust module 300 and a heater 520 disposed inside the exhaust module 300. The heater 520 may be configured in a coil shape to allow the internal temperature of the exhaust module 300 to be maintained at a substantially uniform temperature. FIG. 9 shows an example in which the heating module 500 is applied to the foreline 310 among the components of the exhaust module 300. However, the heating module 500 may be applied to all the components of the exhaust module 300 onto which the carbon byproduct 400 is adsorbed.

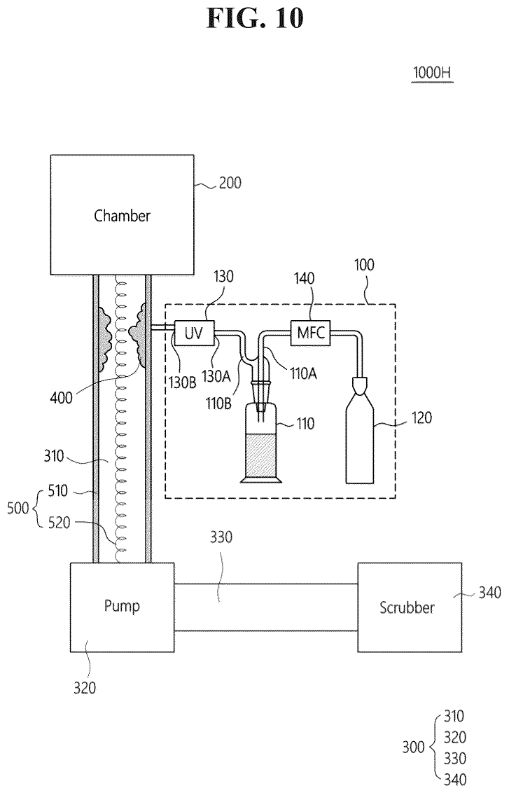

FIG. 10 is a diagram illustrating a carbon byproduct removal system according to some embodiments of the present inventive concept.

Referring to FIG. 10, a carbon byproduct removal system 1000H may be implemented to have a combination of the carbon byproduct removal module 100 attached to the exhaust module 300 and the heating module 500 applied to the exhaust module 300. The carbon byproduct removal module 100 is attached to the point of the inner surface of the exhaust module 300 onto which the carbon byproduct 400, which is discharged from the chamber 200, is adsorbed. Thus, when the heat is applied to the exhaust module 300, the carbon byproduct 400 may be converted into the state in which the carbon byproduct may be easily vaporized. The adsorbed carbon byproduct 400 may be removed by applying the heat to carbon byproduct 400 in the converted state using a heating module 500. In another example, the combination of the carbon byproduct removal module 100 and the heating module 500 may be applied to any one of the components of the exhaust module 300 onto which the carbon byproduct 400 may be adsorbed.

In some embodiments of the present inventive concept, the carbon byproduct 400 may be adsorbed on the inner surface of any component of the exhaust module 300, and thus, should be removed therefrom. However, the carbon byproduct removal module 100 may be attached to a position to which it is difficult to introduce the heating module 500, and thus, may efficiently remove the carbon byproduct 400 therefrom. Furthermore, introducing only one of the heating module 500 and the carbon byproduct removal module 100 to the exhaust module 300 may achieve an effect of removing the carbon byproduct 400. However, the combination of the heating module 500 and the carbon byproduct removal module 100 may be introduced thereto. Thus, the carbon byproduct 400 may be converted into a state that the carbon byproduct 400 may be easily vaporized even at low temperatures, and then the heat may be applied to the exhaust module 300. This may prevent the damage to the exhaust module 300 due to the high temperature.

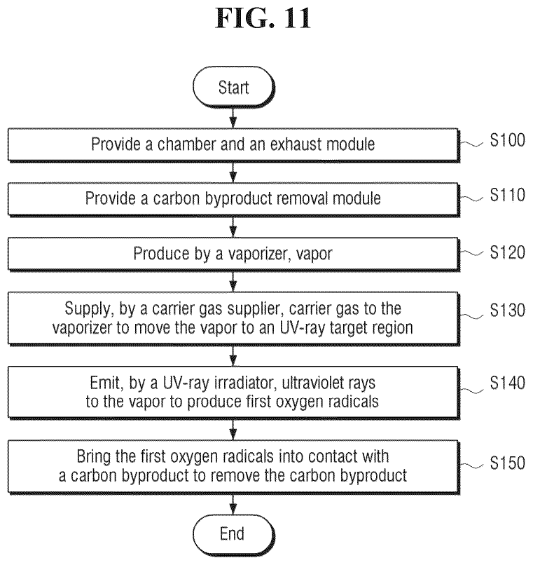

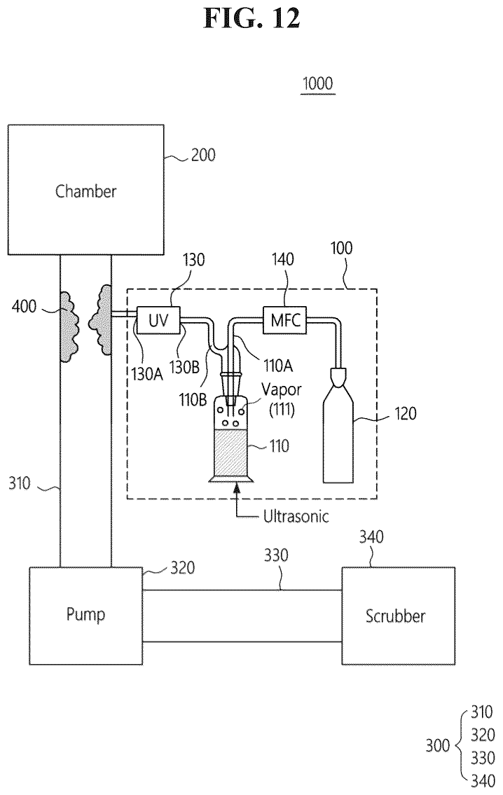

FIG. 11 is a flowchart for illustrating a carbon byproduct removal method according to some embodiments of the present inventive concept. FIG. 12 to FIG. 15 are diagrams of intermediate steps for illustrating the carbon byproduct removal method according to some embodiments of the present inventive concept. Hereinafter, referring to FIG. 11 to FIG. 15, a method of removing the carbon byproduct 400 that is adsorbed to the exhaust module 300 of the chamber 200 by using the carbon byproduct removal module 100 is described.

First, referring to FIG. 11 and FIG. 12, the chamber 200 in which a semiconductor manufacturing process is performed, and the exhaust module 300 connected to the chamber 200 are provided in S100.

Next, the carbon byproduct removal module 100 is attached to a component (for example, the foreline 310) onto which the carbon byproduct 400 is adsorbed among the components 310, 320, 330, and 340 of the exhaust module 300 in S110. Next, the vaporizer 110 is used to produce the vapor 111 including oxygen atoms in S120. For example, the vapor 111 may be produced by generating ultrasonic waves at the bottom of the vaporizer 110 such that the ultrasonic vibration is applied to the liquid contained in the vaporizer 110. In this regard, the liquid included inside the vaporizer 110 may be a material capable of producing the highly reactive oxygen radicals when energy is applied thereto in a vapor state, such as hydrogen peroxide (H₂O₂).

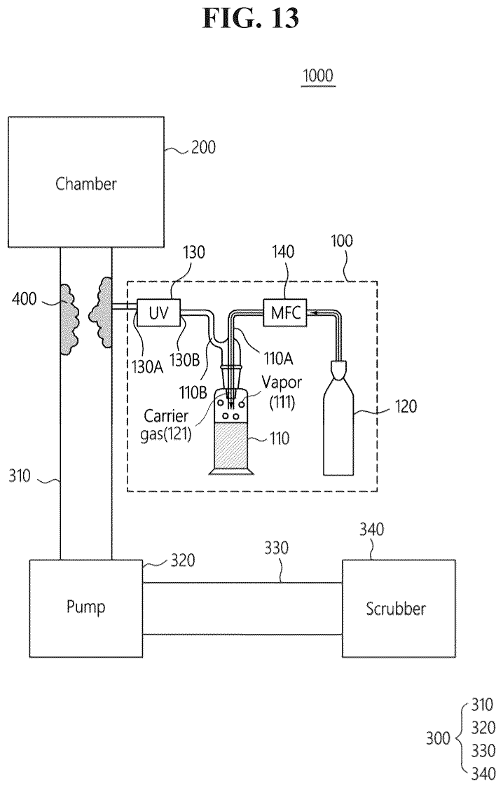

Next, referring to FIG. 11 and FIG. 13, the carrier gas 121 is supplied from the carrier gas supplier 120 to the vaporizer 110, and then, the vapor 111 produced from the vaporizer 110 and the carrier gas 121 flow together to the UV-ray irradiator 130 in S130. In this regard, the mass flow controller 140 may be disposed between the carrier gas supplier 120 and one end 110A of the vaporizer 110 and may move the carrier gas 121 from the carrier gas supplier 120 to the vaporizer 110. The mass flow controller 140 may adjust an amount of the carrier gas 121 flowing from the carrier gas supplier 120 to the vaporizer 110.

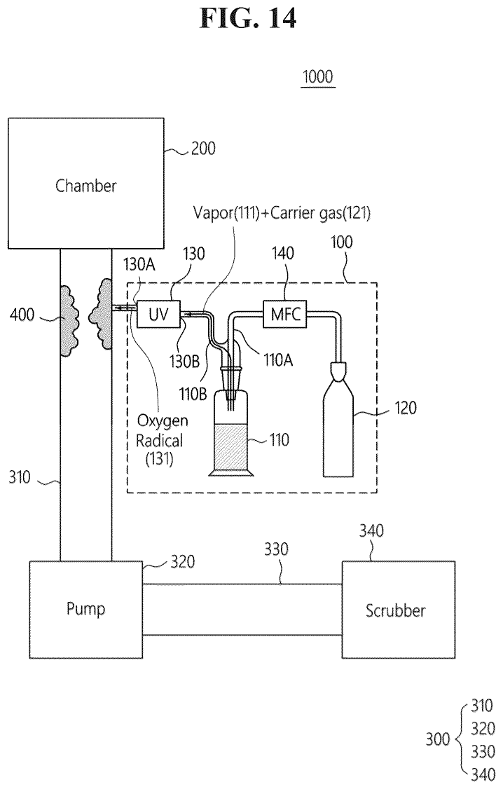

Next, referring to FIG. 11 and FIG. 14, the UV-ray irradiator 130 is used to emit the ultraviolet rays to the vapor 111 to produce first oxygen radicals 131 in S140. In this regard, when the carrier gas 121 which has moved, together with the vapor 111, to the UV-ray irradiator 130, and the vapor 111 includes the CDA or gas including oxygen atoms (O₂), the carrier gas 121 may receive energy from the ultraviolet rays emitted from the UV-ray irradiator 130 to produce second oxygen radicals.

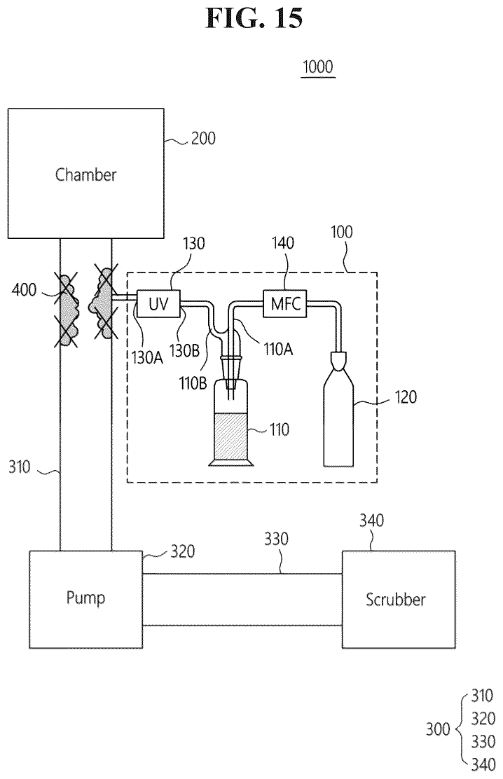

Next, referring to FIG. 11 and FIG. 15, the first oxygen radicals 131 may be supplied to the carbon byproduct 400 deposited on the inner surface of the exhaust module 300 connected to one end 130A of the UV-ray irradiator 130 to remove the carbon byproduct 400 or convert the carbon byproduct 400 into a state in which the carbon byproduct 400 is easily removed in S150. In this regard, when the highly reactive second oxygen radicals are produced from the carrier gas 121, the second oxygen radicals may be supplied into the exhaust module 300 to remove the carbon byproduct 400. Furthermore, in some embodiments of the present inventive concept, the heating module 500 may be disposed in at least a portion of the exhaust module 300 to remove the carbon byproduct 400 adsorbed on the inner surface of the exhaust module 300.

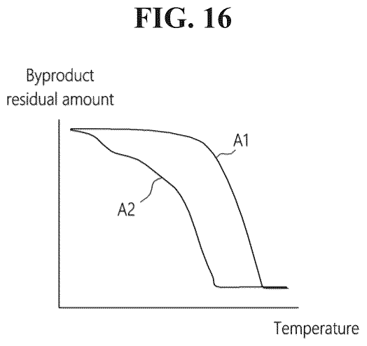

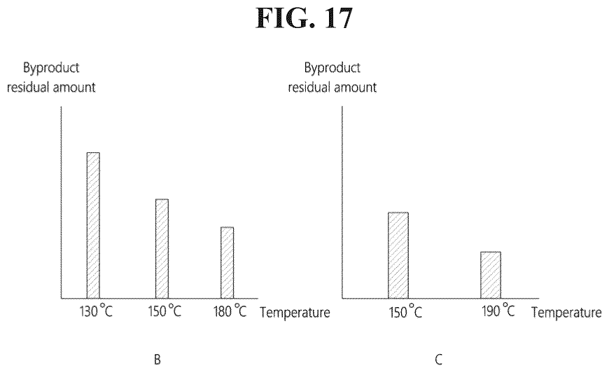

FIG. 16 and FIG. 17 are diagrams illustrating a carbon byproduct removal effect according to some embodiments of the present inventive concept.

Referring to FIG. 16, A1 is a graph corresponding to a case where only the heating module 500 is applied to the exhaust module 300 while the carbon byproduct removal module 100 is not attached to the exhaust module 300. Referring to A1, when the exhaust module 300 is heated using the heating module 500, byproducts may be removed at a specific temperature or higher. A2 is a graph corresponding to a case where the carbon byproduct removal module 100 using the CDA as the carrier gas 121 is applied to the exhaust module 300. Referring to A2, when oxygen radicals react with carbon byproduct 400 inside the exhaust module 300 and the inside of the exhaust module 300 is heated, a temperature at which the byproduct is removed may be lowered compared to that in A1. Furthermore, at the same temperature, a byproduct residual amount may be reduced compared to that in A1. As such, when the carbon byproduct 400 deposited on the inner surface of the exhaust module 300 reacts with the oxygen radicals using the carbon byproduct removal module 100, the carbon byproduct 400 may be decomposed and removed. Further, the carbon byproduct 400 may be converted into the state in which the carbon byproduct 400 may be easily vaporized even at low temperatures, such that the carbon byproduct 400 may be efficiently removed without applying excessive heat to the exhaust module 300.

Next, referring to FIG. 17, B is a graph showing a byproduct residual amount when the temperature of the foreline 310 is gradually increased to 130° C., 150° C., and 180° C. by the heating module 500 while the temperature of the vacuum pump 320 is maintained at about 150° C. C is a graph showing the byproduct residual amount when the temperature of the vacuum pump 320 is gradually increased to 150° C. and 190° C. by the heating module 500 while the temperature of the foreline 310 is maintained at about 180° C. In this way, selectively heating at least some of the components of the exhaust module 300 including the foreline 310 and the vacuum pump 320 using the heating module 500 may allow the carbon byproduct 400 adsorbed on the inner surface of the exhaust module 300 to be removed. In this regard, as the temperature applied to the exhaust module 300 is higher, a larger amount of the carbon byproduct 400 may be removed. However, when the temperature of the exhaust module 300 rises above a certain temperature, damage may occur thereto. Accordingly, when the carbon byproduct 400 is converted into a state in which the carbon byproduct may be easily vaporized at a relatively low temperature using the carbon byproduct removal module 100, the carbon byproduct 400 may be efficiently removed while preventing the damage to the exhaust module 300.

While the present inventive concept has been described with reference to exemplary embodiments thereof, it will be understood by those of ordinary skill in the art that various changes in form and details may be made thereto without departing from the spirit and scope of the present inventive concept.

What is claimed is:

1. A carbon byproduct removal module comprising:
a vaporizer configured to produce vapor including oxygen atoms;
a carrier gas supplier connected to the vaporizer and configured to supply carrier gas to the vaporizer, wherein the carrier gas carries the vapor to a UV-ray irradiator; and
the UV-ray irradiator configured to emit ultraviolet rays to the vapor,
wherein a first end of the UV-ray irradiator is connected to a first end of the vaporizer,
wherein a second end of the UV-ray irradiator is attached to an exhaust module connected to a chamber in which a semiconductor manufacturing process is performed.

2. The carbon byproduct removal module of claim 1, wherein the exhaust module includes a vacuum pump configured to maintain an inside of the chamber in a vacuum state or to discharge a byproduct produced inside the chamber while the semiconductor manufacturing process is performed.

3. The carbon byproduct removal module of claim 2, wherein the exhaust module further includes a foreline connecting the chamber and the vacuum pump to each other.

4. The carbon byproduct removal module of claim 1, wherein a second end of the vaporizer is connected to the carrier gas supplier.

5. The carbon byproduct removal module of claim 4, further comprising a mass flow controller (MFC) connected to and disposed between the carrier gas supplier and the second end of the vaporizer.

6. The carbon byproduct removal module of claim 1, wherein the vaporizer is configured to produce the vapor using hydrogen peroxide.

7. The carbon byproduct removal module of claim 1, wherein the vaporizer is configured to produce the vapor using ultrasonic waves.

8. The carbon byproduct removal module of claim 1, wherein the carrier gas includes at least one of CDA (Clean Dry Air) or oxygen (O₂).

9. A carbon byproduct removal system comprising:
a chamber in which a semiconductor manufacturing process is performed;
an exhaust module connected to the chamber; and
a carbon byproduct removal module attached to the exhaust module and configured to remove a carbon byproduct that is inside the exhaust module,
wherein the exhaust module includes:
a vacuum pump connected to the chamber and configured to maintain an inside of the chamber in a vacuum state or to discharge the byproduct produced in the chamber while the semiconductor manufacturing process is in progress;
a foreline connected to and disposed between the chamber and the vacuum pump;
a scrubber connected to the vacuum pump and configured to remove the byproduct that is produced in the chamber; and
a P-S line connected to and disposed between the vacuum pump and the scrubber,
wherein the carbon byproduct removal module includes:
a vaporizer configured to produce vapor including oxygen;
a carrier gas supplier configured to supply carrier gas to the vaporizer,
wherein the carrier gas carries the vapor to a UV-ray irradiator; and
the UV-ray irradiator configured to emit ultraviolet rays to the vapor.

10. The carbon byproduct removal system of claim 9, further comprising a heating module installed at at least one of the components of the exhaust module.

11. The carbon byproduct removal system of claim 10, wherein the heating module includes a heat jacket covering at least a portion of an outer surface of the exhaust module.

12. The carbon byproduct removal system of claim 10, wherein the heating module includes a coil type heater disposed inside the exhaust module.

13. The carbon byproduct removal system of claim 9, further comprising an auto gate shutoff valve (AGV) connected to and disposed between the chamber and the vacuum pump.

14. The carbon byproduct removal system of claim 9, wherein the vacuum pump is a dry pump.

15. The carbon byproduct removal system of claim 9, further comprising a throttle valve connected to and disposed between the chamber and the foreline.

16. The carbon byproduct removal system of claim 9, wherein the carrier gas includes at least one of argon (Ar) or nitrogen (N₂).

17. A method for removing a carbon byproduct, the method comprising:
providing a chamber in which a semiconductor manufacturing process is performed;
providing an exhaust module configured to exhaust an inside of the chamber;
providing a carbon byproduct removal module configured to remove the carbon byproduct inside the exhaust module; and
attaching the carbon byproduct removal module to the exhaust module to remove the carbon byproduct that is inside the exhaust module,
wherein removing the carbon byproduct that is inside the exhaust module by using the carbon byproduct removal module includes:
producing, by a vaporizer, vapor including oxygen atoms;
supplying, by a carrier gas supplier, carrier gas to the vaporizer such that the carrier gas carries the vapor from the vaporizer to a UV-ray irradiator;
emitting, by the UV-ray irradiator, ultraviolet rays to the vapor to produce first oxygen radicals; and
bringing the first oxygen radicals into contact with the carbon byproduct inside the exhaust module to remove the carbon byproduct.

18. The method of claim 17, wherein removing the carbon byproduct inside the exhaust module using the carbon byproduct removal module further includes:
emitting, by the UV-ray irradiator, ultraviolet rays to the carrier gas to produce second oxygen radicals; and
bringing the second oxygen radicals into contact with the carbon byproduct inside the exhaust module to remove the carbon byproduct,
wherein the carrier gas includes oxygen atoms.

19. The method of claim 17, further comprising:
providing a heat jacket covering at least a portion of an outer surface of the exhaust module; and
providing a coil type heater into the exhaust module.

20. The method of claim 17, wherein the exhaust module includes a vacuum pump configured to maintain the inside of the chamber in a vacuum state or to discharge the byproduct produced that is inside the chamber while the semiconductor manufacturing process is performed.
